(19) United States
(12) Patent Application Publication
(10) Pub. No.: US 2025/0309501 A1
(43) Pub. Date: Oct. 2, 2025

(54) STANDARD TERMINAL, COVER PLATE, AND SECONDARY BATTERY

(71) Applicant: NANJING SHENGSHI PRECISION INDUSTRY CO., LTD., Nanjing (CN)

(72) Inventor: Changchun ZHANG, Nanjing (CN)

(21) Appl. No.: 19/080,946

(22) Filed: Mar. 17, 2025

Related U.S. Application Data
(63) Continuation of application No. PCT/CN2025/072300, filed on Jan. 14, 2025.

(30) Foreign Application Priority Data
Mar. 28, 2024 (CN) 202410368994.6
Oct. 31, 2024 (CN) 202411543381.8

(51) Int. Cl. H01M 50/562; H01M 50/159; H01M 50/16; H01M 50/164; H01M 50/184; H01M 50/188

(52) U.S. Cl. CPC H01M 50/562; H01M 50/159; H01M 50/16; H01M 50/164; H01M 50/184; H01M 50/188

(57) ABSTRACT

The present application discloses standard terminal, cover plate, and secondary battery, relating to the field of battery technology. The standard terminal comprises a lower aluminum ring; a sealing ring, arranged on the lower aluminum ring; a pole, arranged on the top of the sealing ring, the pole comprises an upper end portion and a lower end portion, the outer diameter of the axial surface of the lower end portion is greater than that of the upper end portion, the axial surface of the lower end portion forms a conical surface structure tapering from top to bottom; an upper aluminum ring, arranged on the lower aluminum ring for fixing the pole; an injection molding layer, covering the outer surface of the upper aluminum ring and the pole for isolating the upper aluminum ring and the pole. The cover plate uses the standard terminal, and the secondary battery uses the cover plate.

### TECHNICAL FIELD

The present application relates to the field of battery technology, specifically involving standard terminals, cover plate, and secondary battery.

### BACKGROUND

With the rapid development of technology, secondary batteries, as key components for energy storage and conversion, play a crucial role in various fields such as electric vehicles, energy storage systems, and portable electronic devices. The performance, safety, and production cost of secondary batteries directly affect the market competitiveness of these terminal products and the user experience of consumers. As an important component of secondary batteries, the battery cover plate not only bears the responsibility of sealing the battery cavity and protecting the internal structure of the battery but also serves the function of connecting the battery to external circuits. Its design and manufacturing quality have a critical impact on the overall performance of the battery.

Traditionally, the terminal design on battery cover plates is often customized based on specific battery models or customer requirements. This leads to frequent mold changes and production line adjustments during the manufacturing process, significantly increasing production costs and production cycles. In addition, non-standardized terminal designs also pose compatibility issues during subsequent assembly, testing, and maintenance of the battery, which is not conducive to the standardization and modular development of battery systems. On the other hand, the production of customized terminals often requires high-precision processing equipment and complex process flows, which not only increases production costs but also limits the improvement of production efficiency. At the same time, due to the wide variety of terminals, inventory management becomes complex, increasing the operational burden on enterprises.

In view of the above issues, there is an urgent need within the industry for a battery cover plate terminal design solution that can simplify the production process, reduce production costs, improve production efficiency, and enhance product compatibility.

### SUMMARY

The purpose of the present application is to provide a standard terminal to address the issues of high production costs and long production cycles caused by the customized development of traditional terminals. It also addresses compatibility issues encountered during subsequent assembly, testing, and maintenance processes, as well as the problem of low production efficiency.

The objectives of the present application can be achieved through the following technical solutions:

The standard terminal comprises:
a lower aluminum ring;
a sealing ring, arranged on the lower aluminum ring;
a pole, arranged on top of the sealing ring, wherein the pole comprises an upper end portion and a lower end portion, the outer diameter of the axial surface of the lower end portion is greater than that of the upper end portion, and the axial surface of the lower end portion forms a conical surface structure tapering from top to bottom;
an upper aluminum ring, arranged on the lower aluminum ring for fixing the pole;
an injection molding layer, covering the outer surface of the upper aluminum ring and the pole for isolating the upper aluminum ring and the pole.

Preferably, an isolation layer is arranged between the pole and the upper aluminum ring.

Preferably, the isolation layer is made of ceramic material, mica sheet, or hard plastic.

Preferably, the lower aluminum ring has a stepped structure, with the number of steps being 1 to 3 layers.

Preferably, a through hole is provided in the middle of the lower aluminum ring.

Preferably, the lower end of the sealing ring extends downward to form a stopper part, and the stopper part extends into the through hole.

Preferably, the axial surface of the sealing ring and the axial surface of the stopper part are both arranged at intervals from the matching surface of the lower aluminum ring.

Preferably, the cross-section of the pole is an inverted T-shape, or, a boss extends from the bottom surface of the lower end portion of the pole (1), and the cross section of the boss is cross-shaped.

Preferably, the pole is a positive pole or a negative pole, wherein the positive pole is made of aluminum material, and the negative pole is made of copper-aluminum composite material.

Preferably, the upper end portion of the negative pole is made of aluminum material, and the lower end portion is made of copper material.

Preferably, the cross-section of the upper aluminum ring has a Z-shaped structure.

Preferably, the upper part of the upper aluminum ring is in contact with the upper end of the isolation layer, and the lower part of the upper aluminum ring is in contact with the lower aluminum ring.

Preferably, the space between the upper part of the upper aluminum ring and the upper end portion of the pole is configured to be filled with the injection molding layer.

Preferably, the injection molding layer is formed by injection molding of insulating material or weak conductive material.

Preferably, the insulating material is configured for the standard terminal of the pole (1) made of copper-aluminum composite material or aluminum material.

Preferably, the weak conductive material is configured for the standard terminal of the pole made of aluminum material.

Preferably, the cover plate uses the aforementioned standard terminal.

Preferably, the secondary battery uses the aforementioned cover plate.

Compared with the prior art, the beneficial effects of the present application are: through the standardized design of the terminal, not only can the number of mold changes be reduced, but also the number of molds for different models of battery cover plates can be reduced, optimizing the production line configuration, and promoting the standardized production of terminal components, further reducing costs through economies of scale and enhancing market competitiveness. In addition, standardized design helps simplify the battery assembly process, improve assembly efficiency, and reduce the failure rate caused by terminal mismatches, thereby enhancing the overall quality and reliability of the battery system.

### BRIEF DESCRIPTION OF THE DRAWINGS

The application will be further described below in conjunction with the accompanying drawings.

FIG. 1 is a schematic diagram of the overall structure of the application.

In the FIGURE: 1, Pole; 2, Lower Aluminum Ring; 3, Sealing Ring; 4, Injection molding layer; 5, Upper Aluminum Ring; 1-1, Isolation Layer.

### DETAILED DESCRIPTION

The technical solutions in the embodiments of the present application will be clearly and completely described below in conjunction with the accompanying drawings of the embodiments of the present application. It is apparent that the described embodiments are only part of the embodiments of the present application, not all of them. Based on the embodiments in the present application, all other embodiments obtained by those skilled in the art without making creative efforts are within the scope of protection of the present application.

### Embodiment One

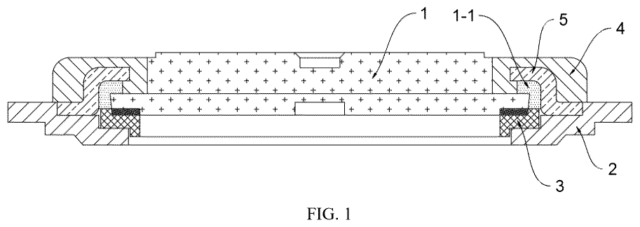

As shown in FIG. 1, a standard terminal comprises a pole 1, a lower aluminum ring 2, a sealing ring 3, an injection molding layer 4, and an upper aluminum ring 5. The sealing ring 3 is arranged in the middle of the lower aluminum ring 2, while the pole 1 is arranged on top of the sealing ring 3. The pole 1 comprises an upper end portion and a lower end portion, the outer diameter of the axial surface of the lower end portion is greater than that of the upper end portion. The upper aluminum ring 5 is arranged on top of the lower aluminum ring 2 for fixing the pole 1, and the outer surfaces of the upper aluminum ring 5 and the pole 1 are covered with an injection molding layer 4 for physical isolation.

In this embodiment, the standard terminal is used for secondary batteries, adapting to different models of batteries and different sizes of battery cover plates, and the standard terminal in this embodiment is processed separately.

In this embodiment, by setting the standard terminal, the terminals on various models of battery cover plates are standardized and stripped, which simplifies the production process of the battery cover plate. During production, the battery cover plate does not require processing related to the terminal structure, only the connection port structure for connecting the standard terminal of this embodiment needs to be processed. Moreover, due to the standardization of the terminals, there is no need for different processing and assembly for different models of terminals, thereby simplifying the production process and improving production efficiency.

At the same time, in this embodiment, the standardized design and separate processing of standard terminals can not only reduce the frequency of mold changes and optimize production line configuration, but also promote the standardized production of terminal components. By utilizing economies of scale, costs can be further reduced, thereby enhancing market competitiveness. In addition, standardized design helps simplify the battery assembly process, improve assembly efficiency, and reduce the failure rate caused by terminal mismatches, thereby enhancing the overall quality and reliability of the battery system. Compared to traditional terminal injection molding, the standard terminal in this embodiment does not need to be injection molded together with the battery cover plate, which improves the space utilization of the injection mold cavity, allows for more cavities per injection, increases efficiency, and further reduces costs.

Moreover, standard terminals ensure that the terminals on the battery cover plates using these terminals have the same quality and performance, thereby improving the overall consistency of the product. Further, terminals designed and processed through standardization will have significantly enhanced connection reliability and electrical performance, thereby enhancing the reliability of the battery cover plate and further improving the reliability of the corresponding battery.

Furthermore, standardized terminals allow maintenance personnel to more easily identify and replace damaged terminals, thereby simplifying the maintenance process. Since standard terminals can be individually processed and replaced, there is no need to replace the entire battery cover plate, thus reducing maintenance costs.

### Embodiment Two

As shown in FIG. 1, the difference from Embodiment One is that in this Embodiment, an isolation layer 1-1 is arranged between the pole 1 and the upper aluminum ring 5. This isolation layer 1-1 is made of ceramic material, mica sheet, or hard plastic, possessing excellent heat resistance and insulation properties. It insulates the upper aluminum ring 5 and the pole 1, and is injection molded onto the pole 1, thereby providing a heat insulation effect. This addresses the airtightness issue caused by the aging of the sealing ring 3, while also enhancing safety performance by adding the isolation layer 1-1.

It is worth noting that the axial surface of the lower end portion of pole 1 has a conical surface structure that tapers from top to bottom, forming an undercut. This enhances the adhesion of the plastic part during the injection molding of isolation layer 1-1, preventing the isolation layer 1-1 from falling off.

### Embodiment Three

As shown in FIG. 1, unlike Embodiment One and Embodiment Two, in this embodiment, the lower aluminum ring 2 is provided with a stepped structure. The lower aluminum ring 2 is made of aluminum material and the stepped structure is formed by stamping. The sealing ring 3 and the upper aluminum ring 5 are installed in coordination with different stepped surfaces to avoid mutual interference during assembly, ensuring installation stability. At the same time, the stepped assembly optimizes the fit and position of each component, reducing the size of the standard terminal, saving material costs. Additionally, the stepped structure at the bottom of the lower aluminum ring 2 is used for welding and combining with various types of battery cover plates, achieving stable installation of the standard terminal.

It is noteworthy that the number of stepped layers for the stamping of the lower aluminum ring 2 is 1 to 3 layers, designed according to actual production needs. A through hole is also provided in the middle of the lower aluminum ring 2 to meet practical requirements.

### Embodiment Four

As shown in FIG. 1, unlike Embodiment One, Embodiment Two, or Embodiment Three, in this Embodiment, the lower end portion of the sealing ring 3 extends downward with a stopper part. The stopper part is set extends into the through hole, which allows for the positioning between the sealing ring 3 and the lower aluminum ring 2, while also enhancing the sealing performance.

It is also noteworthy that the axial surface of the sealing ring 3 and the axial surface of the stopper part are both arranged at intervals from the matching surface of the lower aluminum ring 2, thereby meeting the deformation space requirements needed during the assembly and extrusion of the sealing ring 3, further ensuring sealing performance.

### Embodiment Five

As shown in FIG. 1, the difference from Embodiment One, Two, Three, or Four is that in this embodiment, the cross-section of Pole 1 is an inverted T-shape, or the bottom surface of the lower end portion of Pole 1 further extends to form a boss, with a cross-shaped section.

Furthermore, Pole 1 comprises both positive and negative poles. Depending on actual requirements, the type of Pole 1 is set in the standard terminal, where the positive pole is made of aluminum material, and the negative pole is made of copper-aluminum composite material. The upper end portion of the negative pole is aluminum, and the lower end portion is copper, facilitating welding with the negative electrode cell (copper material).

### Embodiment Six

As shown in FIG. 1, the difference from Embodiment One, Embodiment Two, Embodiment Three, Embodiment Four, or Embodiment Five is that in this embodiment, the cross-section of the Upper Aluminum Ring 5 has a Z-shaped structure. This Z-shaped structure allows it to stably fit with the stepped surface of the Lower Aluminum Ring 2 and also provides a stable compressive effect on the Isolation Layer 1-1.

It is noteworthy that in this embodiment, the upper part of the Z-shaped structure of the Upper Aluminum Ring 5 fits with the upper end portion of the Isolation Layer 1-1, and the lower part of the Z-shaped structure of the Upper Aluminum Ring 5 fits with the stepped surface of the Lower Aluminum Ring 2, achieving stable support and compressive effects.

### Embodiment Seven

As shown in FIG. 1, the difference from Embodiment One, Two, Three, Four, Five, or Six is that in this embodiment, the upper part of the upper aluminum ring 5 is suitable for filling with the injection molding layer 4 between it and the upper end portion of the pole 1, which improves the adhesion of the injection molding layer 4 while providing thermal insulation for the pole 1.

Furthermore, it should be noted that the injection molding layer 4 can be formed by injection molding of insulating material or weak conductive material, where the insulating material is suitable for the standard terminal of the pole 1 made of copper-aluminum composite material or aluminum material, while the weak conductive material is suitable for the standard terminal of the pole I made of aluminum material.

### Embodiment Eight

This embodiment provides a cover plate that uses any of the standard terminals from Embodiments One to Seven mentioned above. Due to the use of standard terminals, the cover plate in this embodiment only requires processing of the corresponding connection ports. The standard terminals are welded to the corresponding positions through laser welding, and cover plates of different sizes can all be adapted to the standard terminals.

### Embodiment Nine

This embodiment provides a secondary battery that uses the cover plate with standard terminals from Embodiment Eight, enhancing the reliability of the secondary battery.

In the description of the present application, it should be understood that terms such as ‘upper’, ‘lower’, ‘left’, ‘right’, etc., indicating directions or positional relationships, are based on the directions or positional relationships shown in the drawings. They are merely for the convenience of describing the application and simplifying the description and are not intended to indicate or imply that the referenced devices or elements must have specific orientations, configurations, or operations. Therefore, they should not be construed as limitations on the application. In addition, ‘first’ and ‘second’ are used solely for descriptive purposes and should not be understood as indicating or implying relative importance or implicitly specifying the number of technical features indicated. Therefore, features denoted as ‘first’ and ‘second’ may explicitly or implicitly comprise one or more of such features. In the description of the present application, unless otherwise specified, the term ‘multiple’ means two or more.

In the description of the present application, it should be noted that unless otherwise explicitly specified and defined, terms such as ‘arrange’, ‘connect’, and ‘link’ should be understood in a broad sense. For example, they can refer to fixed connections, detachable connections, or integral connections; they can be mechanical connections or electrical connections; It can be directly connected or indirectly connected through an intermediary medium, and it can be the internal connection of two components. For ordinary technicians in the field, the specific meaning of the above terms in the present application can be understood according to specific circumstances.

The above provides a detailed description of an embodiment of the present application, but the content is merely a preferred embodiment and should not be considered as limiting the scope of implementation of the present application. Any equivalent changes and improvements made within the scope of the claims of the present application should still fall within the patent coverage of the present application.

What is claimed is:

1. A standard terminal, characterized in that the standard terminal comprising:
a lower aluminum ring (2);
a sealing ring (3), arranged on the lower aluminum ring (2);
a pole (1), arranged on top of the sealing ring (3), wherein the pole (1) comprises an upper end portion and a lower end portion, the outer diameter of the axial surface of the lower end portion is greater than that of the upper end portion, and the axial surface of the lower end portion forms a conical surface structure tapering from top to bottom;
an upper aluminum ring (5), arranged on the lower aluminum ring (2) for fixing the pole (1);
an injection molding layer (4), covering the outer surface of the upper aluminum ring (5) and the pole (1) for isolating the upper aluminum ring (5) and the pole (1).

2. The standard terminal according to claim 1, characterized in that an isolation layer (1-1) is arranged between the pole (1) and the upper aluminum ring (5).

3. The standard terminal according to claim 2, characterized in that the isolation layer (1-1) is made of ceramic material, mica sheet, or hard plastic.

4. The standard terminal according to claim 1, characterized in that the lower aluminum ring (2) has a stepped structure, with the number of steps being 1 to 3 layers.

5. The standard terminal according to claim 1, characterized in that a through hole is provided in the middle of the lower aluminum ring (2).

6. The standard terminal according to claim 5, characterized in that the lower end of the sealing ring (3) extends downward to form a stopper part, and the stopper part extends into the through hole.

7. The standard terminal according to claim 6, characterized in that the axial surface of the sealing ring (3) and the axial surface of the stopper part are both arranged at intervals from the matching surface of the lower aluminum ring (2).

8. The standard terminal according to claim 1, characterized in that the cross-section of the pole (1) is an inverted T-shape;
or, a boss extends from the bottom surface of the lower end portion of the pole (1), and the cross section of the boss is cross-shaped.

9. The standard terminal according to claim 8, characterized in that the pole (1) is a positive pole or a negative pole, wherein the positive pole is made of aluminum material, and the negative pole is made of copper-aluminum composite material.

10. The standard terminal according to claim 9, characterized in that the upper end portion of the negative pole is made of aluminum material, and the lower end portion is made of copper material.

11. The standard terminal according to claim 2, characterized in that the cross-section of the upper aluminum ring (5) has a Z-shaped structure.

12. The standard terminal according to claim 11, characterized in that the upper part of the upper aluminum ring (5) is in contact with the upper end of the isolation layer (1-1), and the lower part of the upper aluminum ring (5) is in contact with the lower aluminum ring (2).

13. The standard terminal according to claim 11, characterized in that the space between the upper part of the upper aluminum ring (5) and the upper end portion of the pole (1) is configured to be filled with the injection molding layer (4).

14. The standard terminal according to claim 10, characterized in that the injection molding layer (4) is formed by injection molding of insulating material or weak conductive material.

15. The standard terminal according to claim 14, characterized in that the insulating material is configured for the standard terminal of the pole (1) made of copper-aluminum composite material or aluminum material.

16. The standard terminal according to claim 14, characterized in that the weak conductive material is configured for the standard terminal of the pole (1) made of aluminum material.

17. Cover plate, characterized in that the cover plate uses the standard terminal according to claim 1.

18. Secondary battery, characterized in that the secondary battery uses the cover plate according to claim 17.
